(19) United States
(12) Patent Application Publication
(10) Pub. No.: US 2004/0203721 A1
(43) Pub. Date: Oct. 14, 2004

(54) System and method for managing call quality and system performance in a telecommunication system

(76) Inventor: Paul C. Grooms, Alpharetta, GA (US)

Correspondence Address: CINGULAR WIRELESS, LLC., 5565 Glenridge Connector, #920, Atlanta, GA, 30342, US

(21) Appl. No.: 10/232,043

(22) Filed: Aug. 30, 2002

(51) Int. Cl. H04B 17/00; H04Q 7/20

(52) U.S. Cl. 455/423; 455/67.11

(57) ABSTRACT

A method for providing status data in a telecommunications system is disclosed. The method comprises monitoring call performance at base stations. Next, the method transmits and stores the call performance data in a database. The method then receives call performance parameters from a user and generates a status report based on the call performance parameters. The status report is subsequently transmitted to the user.

### TECHNICAL FIELD

This invention relates to the field of wireless telecommunications, and more specifically, a system for and method of managing call quality and network performance in a wireless communications network.

### BACKGROUND

Nowhere has the explosion of modern technology been more evident than in the field of wireless communication. Wireless communication devices such as mobile telephones, pagers, and wireless PDAs have become ubiquitous. This explosion, however, also generates a growing need for assuring the quality and performance of wireless communication networks.

To assess the quality and performance of such a network, one known measurement technique includes tracking performance information regarding communications occurring within the network. For example, call performance information may include the duration of each communication, number of communications dropped, number of communications failing handoff, etc.

This information is collected and stored within a database. The database may be maintained by a performance metering tool, such as the Metrica/NPR (Network Performance Reporting)™ product marketed by ADC Telecommunications of Eden Prairie, Minn. Clients desiring information regarding particular cells or areas may then query the database to produce individualized reports. These reports may then be printed and used to identify problems such as cell(s) reporting a large number of dropped calls or cell(s) that have stopped reporting altogether.

In addition, clients may also query the database to detect faults arising in a wireless communication system. Faults may cause one or more elements of a communication system, such as a base station or a base station controller, to provide incorrect information or cease receiving or generating information altogether. Clients may therefore execute and print individualized reports to detect if any element(s) is experiencing difficulties. This may be accomplished by comparing the provided information against known, correct information.

Accordingly, in order to detect actual and potential problems within a communications network, such as equipment failure, insufficient resources, and the like, it was necessary for a client to execute a report. This, however, places a burden not only upon the computer executing such a report but also the client. For example, each query requires the use of resources such as processor load and processing time. Therefore, excessive queries may significantly slow down or even overload the processor. Moreover, if multiple clients request multiple reports, it may take a significant time to run each report, thereby costing clients significant down time. Similarly, clients may spend considerable time attempting to verify information by comparing it with known information.

Thus, a method and system for accurately and efficiently assessing call-quality and network performance within a wireless communication network would greatly enhance the efficiency of users and the level of customer satisfaction.

In addition, because each printed report may be large, a client may have difficulty in sorting and/or otherwise managing the report(s). Accordingly, a method and system for accurately and efficiently transmitting and displaying the reports would likewise enhance the efficiency of users and the level of customer satisfaction.

### SUMMARY OF THE INVENTION

In accordance with an aspect of the present invention, a method for providing status data in a telecommunications system is disclosed. The method comprises monitoring call performance at base stations. Next, the method transmits and stores the call performance data in a database. The method then receives call performance parameters from a user and generates a status report based on the call performance parameters. The status report is subsequently transmitted to the user.

In accordance with another aspect of the present invention, a method for managing quality and service in a telecommunications system is disclosed. The method comprises transmitting call performance parameters. Next the method schedules a status report based on the call performance parameters, wherein the status report is generated at the scheduled time. The generated status report is then received.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 illustrates a diagram of a performance management system in an exemplary embodiment consistent with the present invention.

FIG. 2 illustrates a flow chart of a method for scheduling performance reports in an exemplary embodiment consistent with the present invention.

FIG. 3 illustrates a flow chart of a method for verifying data integrity and providing remedial information in an exemplary embodiment consistent with the present invention.

FIGS. 4A-4D illustrate a diagram of a graphical user interface in an exemplary embodiment consistent with the present invention.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

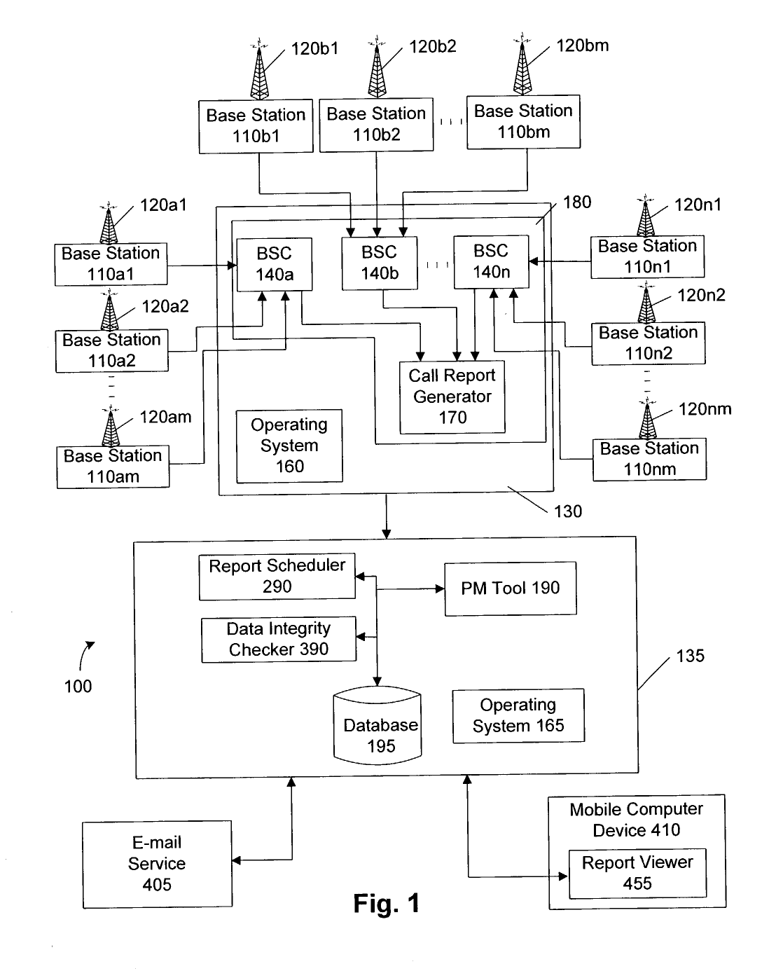

FIG. 1 illustrates a block diagram of an exemplary wireless communication system 100 in accordance with methods and systems consistent with the invention. The blocks illustrated in FIG. 1 may be implemented in a variety of hardware, both analog and digital, and software aspects, known to those skilled in the art. In addition, parts of the description will be presented in terms of operations performed by logical entities or computer systems under software control consistent with the manner commonly employed by those skilled in the art to convey the substance of their work to others skilled in the art. As known to those skilled in the art, these quantities take the form of electrical, magnetic, or optical signals capable of being stored, transferred, combined, and otherwise manipulated through mechanical and electrical components of a computer system; and the computer system includes general purpose as well as special purpose data processing machines, systems, and the like, that are standalone, adjunct, or embedded.

As illustrated, one or more base stations 110 are connected to a server data observation device (“SDO”) 180 through its respective base station controller (“BSC”) 140. Each base station 1 10 is connected to an antenna array 120 through which communication is established with wireless devices. The wireless devices (not shown) used to communicate in wireless communication system 100 may include, for example, a standard wireless phone, a third generation cellular device, a personal digital assistant, or any other type of wireless device. Moreover, communications between base stations 110 and their respective wireless devices may be implemented using any wireless communication protocol, such as code-division multiple access (“CDMA”), wide-band code-division multiple access (“W-CDMA”), time-division multiple access (“TDMA”), Global System for Mobile Communications (“GSM”), General Packet Radio Service (“GPRS”), and the like.

Each base station 110 generally communicates with wireless devices located in a particular cell, where each cell covers a specific geographical area. Using their antenna arrays 120, base stations 110 may further subdivide the cells into multiple, overlapping sectors. The overlapping sectors may provide soft-handoff capability, thus allowing a wireless device to simultaneously communicate with two or more base stations 110. A detailed explanation of how data is communicated using an exemplary communications protocol, W-CDMA is provided in the 3GPP standards: Physical Layer: 3GPP TS 25-200 Series (Release 1999); UE-UTRAN radio interface: 3GPP TS 25-300 Series (Release 1999); and UTRAN lu, lur, lub interfaces: 3GPP TS 25-400 series (Release 1999); the contents of which are incorporated herein by reference in their entireties.

In addition, in accordance with aspects of the present invention, each base station 110 generates call performance data regarding the communications occurring within its respective cell based on call performance parameters. Call performance parameters may include, for example: the date, time, and duration of the calls, the number of calls dropped, the number of calls failing handoff, the number of calls successfully completing handoff, etc.

In one embodiment of the present invention, base stations 110 generate data based on over 1200 call performance parameters. It should be appreciated that any parameter may be defined and tracked and thus aspects of the present invention may be performed with more than 1200 call performance parameters. Alternatively, base stations 110 may track less than 1200 call performance parameters depending on the particular needs of the users. The data generated based on the call performance parameters may be stored using counters. For example, a dropped call may increment one counter tracking the number of dropped calls and decrement another counter tracking the total number of active calls for a particular time period. Those skilled in the art-should appreciate, however, alternative means for tracking call performance may be used.

Referring back to FIG. 1, SDO 180 is shown comprising one or more BSC 140. Operations of BSC 140 are well known and generally include, among others, assisting with call processing and transmission/networking interfacing. In accordance with aspects of the present invention, operations of BSC 140 may also include receiving call performance data from the base stations 110. While only one SDO 180 is illustrated, those skilled in the art should appreciate that wireless communication system 100 may include one or more SDO 180.

As illustrated in FIG. 1, SDO 180 may also comprise a call report generator 170. As call performance data is received at the BSC 140, the call report generator 170 collects the data and generates a report based on specified parameters. For example, in one embodiment of the present invention, the call report generator 170 may use an extraction script to collect the raw call performance data provided to each BSC 140. The generated report may be in the form of a delimited text file, such as a comma delimited file. In accordance with an exemplary embodiment of the present invention, call report generator 170 may also collect information regarding the source of the cell performance data, e.g., the originating cell, base station, BSC, MSC, and the like.

Those skilled in the art should appreciate that the BSC 140, call report generator 170, and SDO 180 are logical entities, and therefore may be implemented in the same or different locations. For example, in one embodiment of the present invention, call report generator 170 is implemented with multiple BSCs 140 on a standalone computer 130 running the UNIX™ operating system 160, such as a SUN Ultra 5™ marketed by SUN Microsystems of Palo Alto, Calif. Alternatively, it should also be appreciated that SDO 180 may be implemented with an Operation and Maintenance Center Radio Part (“OMCR”) coupled with a reporting feature. As is well known to those skilled in the art, an OMCR is generally responsible for the operations and general maintenance of the radio portion of wireless communication system 100 and maintains configuration information for each cell.

Referring back to FIG. 1, SDO 180 is also shown connected to a Performance Metering (“PM”) tool 190. In accordance with aspects of the present invention, PM tool 190 may be any performance management toolset that assists in managing the quality of service and/or the capacity of wireless communication networks. For example, in one embodiment of the present invention, PM tool 190 may comprise the Metrica/NPR™ product. The PM tool 190 may be implemented on the same computer as SDO 180 or on a separate computer. In one embodiment of the present invention, PM tool 190 may be implemented on a separate standalone computer 135 running the UNIX™ operating system 165, such as a SUN Enterprise 4500™ marketed by SUN Microsystems of Palo Alto, Calif.

PM tool 190 assists in the management of networks by receiving call performance data from SDO 180 and parsing that data to determine existing and/or potential problem areas within a wireless network. For example, in accordance with aspects of the present invention, PM tool 190 monitors wireless communication system 100 by periodically extracting the call performance text files generated by call report generator 170 and using that information to identify problems such as cell(s) reporting a large number of dropped calls and cell(s) that have stopped reporting altogether. As should be appreciated, these types of problems can be indicative of, for example, cells having defective equipment or cells requiring additional radios.

PM tool 190 stores this information on an associated storage device. As shown, the storage device may comprise a database 195 for storing the call performance data. Users desiring information regarding particular parameters and cells may then query the database to produce individualized reports. In accordance with aspects of the present invention, users may access PM tool 190 and its associated database both locally and remotely. It should be appreciated, however, that each query may require the use of resources such as processor load on computer 135. Therefore, excessive queries may significantly slow down or even overload the processor. For example, if multiple users in the field login remotely and request multiple reports, it may take a significant time to run each report, thereby costing users significant down time.

Referring back to FIG. 1, a report scheduler 290 is shown connected to PM tool 190 in accordance with one embodiment of the present invention. Report scheduler 290 provides a method for scheduling one or more reports for one or more users. Reports are preferably scheduled during periods of low processor use, such as late evening to early morning. In accordance with one embodiment of the present invention, a computer program, or script, may be used to implement report scheduler 290. The script may include a cron daemon (e.g., using the UNIX “crontab” command) to execute the program on a periodic basis (e.g., hourly, daily, or weekly). It should be appreciated that the script may be implemented in many different ways. For example, the script may independently create a predefined report using information found in database 195. Alternatively, the script may access or be incorporated into PM tool 190, allowing PM tool 190 to generate the desired report based on user defined parameters.

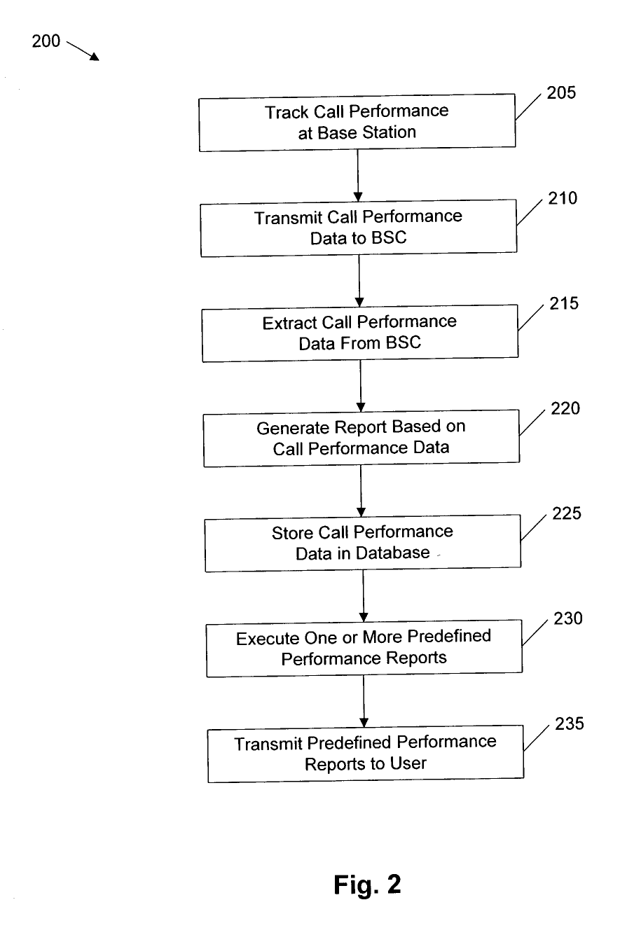

In one embodiment of the present invention, the script may directly call the relevant reporting executable from PM tool 190 without having to go through the tool's front end. It should be appreciated that additional resources may be conserved by generating reports using scripts and bypassing the overhead generated by an instance of PM tool 190. However, it should likewise be appreciated that generating reports using the PM tool 190 offers benefits such as use and implementation. Report scheduler 290 will be further described below with reference to FIG. 2.

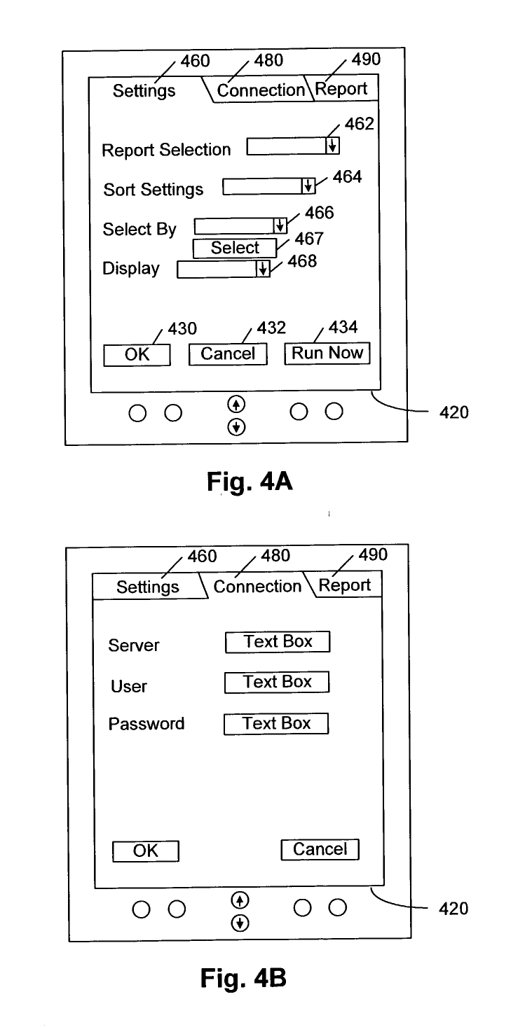

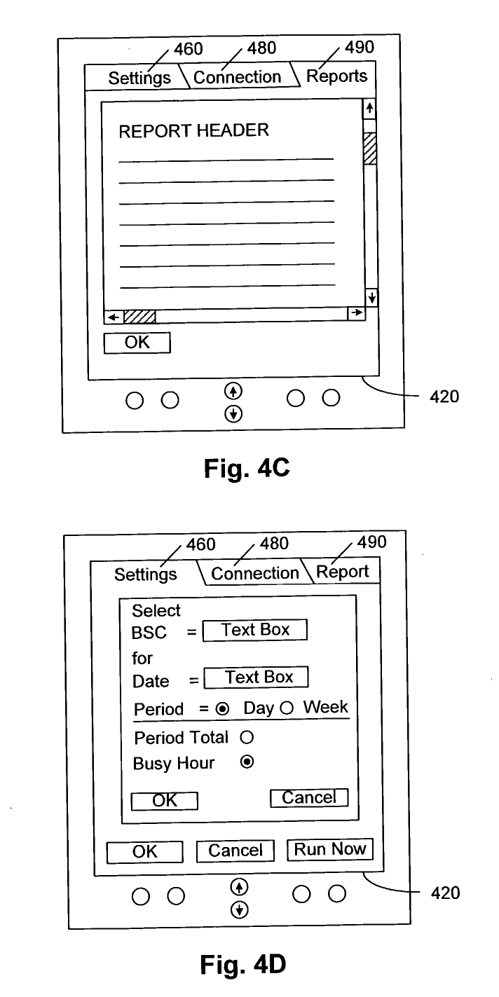

Referring again to FIG. 1, upon executing a report, data integrity checker 390 may transmit the report to the appropriate user(s). For example, in one embodiment of the present invention, a completed report is first redirected to a temporary text file and then transmitted to a user using an electronic mail service 405. In an additional embodiment of the present invention, a completed report may be transmitted to a user via the Internet, for example, through the access of a secured website. In another embodiment of the present invention, a completed report may be transmitted to a user's mobile computing device 410, such as a Personal Digital Assistant (“PDA”). An exemplary method and graphical user interface for transmitting a report to-mobile computing device 410 will be further described with respect to FIGS. 4A-4D.

Still referring to FIG. 1, PM tool 190 is also shown connected to data integrity checker 390 in accordance with an exemplary embodiment of the present invention. As described above, information, such as call performance data, is transmitted from base stations 110 to their respective SDO 180 via their respective BSC 140. That information is then collected and used to populate database 195 by PM tool 190. It should be appreciated, however, that faults arising in wireless communication system 100 may cause failures affecting elements of the system 100, such as SDO 180, BSC 140, and/or base station 110. Accordingly, when such a failure occurs, one or more elements of system 100 may cease to receive or generate information. In one embodiment of the invention, that information may comprise the call performance data used by PM tool 190 to manage the quality of service and/or the capacity of wireless communication networks.

Data integrity checker 390 provides a method of determining malfunctioning elements of communication system 100 by accessing database 195 to verify the information provided by the elements. In accordance with one embodiment of the present invention, data integrity checker 390 provides a method for determining missing cells by determining which elements are not providing information. For example, data integrity checker 390 may verify the information provided by each SDO 180, BSC 140, and base station 110.

In accordance with one embodiment of the present invention, data integrity checker 390 schedules a report to verify that information has been provided by each element and that the provided information is correct. For example, data integrity checker 390 may verify that each SDO 180 correctly identified its respective base stations and cells. This may be accomplished by comparing a provided cell name associated with a particular cell identification against the known, correct cell name. If data integrity checker 390 determines that an incorrect cell name was provided, such as when a changed cell name was not updated, data checker 390 can provide the correct cell name. It should be appreciated that additional information, such as a list of correct cell names, may be stored in database 195 or outside database 195 (e.g., an OMCR). Accordingly, in one embodiment of the invention, data integrity checker 390 not only verifies information but also provides corrective information.

It should be appreciated, however, that it is unnecessary for the data integrity checker 390 to verify all the information provided by each element. For example, data integrity checker 390 may verify only the information from each SDO 180 for a predefined period of time as identified by a user. It should be appreciated that elements showing very little or no information may indicate potential failures.

In accordance with one embodiment of the present invention, a script may be used to implement data integrity checker 390. The script may include a cron daemon to execute the program on a periodic basis (e.g., hourly, daily, or weekly). It should be appreciated that the script may be implemented in many different ways. For example, the script may independently create a predefined report using information found in database 195. Alternatively, the script may access or be incorporated in PM tool 190, allowing the PM tool 190 to generate the desired report based on user-defined parameters. Similarly, like the report scheduler 290 described above, the data integrity checker 390 may directly call the relevant reporting executable from PM tool 190 without having to go through the tool's front end.

Referring again to FIG. 1, upon executing a report, data integrity checker 390 may transmit the report to the appropriate user(s). For example, in one embodiment of the present invention, a completed report is first redirected to a temporary text file and then transmitted to a user using electronic mail service 405 or the Internet. In another embodiment of the present invention, a completed report may be transmitted to user's mobile computing device 410, such as a PDA. An exemplary method and graphical user interface for transmitting a report to mobile computing device 410 will be further described with respect to FIGS. 4A-4D.

Now referring to FIG. 2, a flow chart of method 200 for scheduling and transmitting reports performed by report scheduler 290 in accordance with an exemplary embodiment of the present invention is illustrated. At stage 205, base stations 110 track call performance data within their respective cells and sectors. As previously described, call performance data is generated based on call performance parameters, which may be preset according to the needs of the users. At stage 210, the call performance data is transmitted to each respective BSC 140. At stage 215, call report generator 170 receives that information from each BSC 140, including information regarding which BSC, base station, cell, and sector generated the call performance data. It should be appreciated that call report generator 170 may extract information from BSC 140 periodically, as requested, or whenever that information becomes available. At stage 220, call report generator 170 parses the call performance data and generates a report such as a delimited text file. At stage 225, PM tool 190 receives one or more reports from call report generator 170 and loads that information onto query-enabled database 195. Like stage 215, it should be appreciated that PM tool 190 may extract information from call report generator 170 periodically, as requested, or whenever that information becomes available.

At stage 230, report scheduler 290 executes one or more predefined reports. For example, each user may define one or more reports regarding one or more cells. Moreover, the reports may be individualized to include or exclude specified call performance parameters. Preferably, these reports are run during times when the processor has a light load. At stage 235, the predefined reports are transmitted to the requesting user. It should be appreciated that a requesting user may comprise a person or machine who has (1) presubscribed to accept one or more reports; (2) part of a maintenance report team; or (3) requested one or more reports.

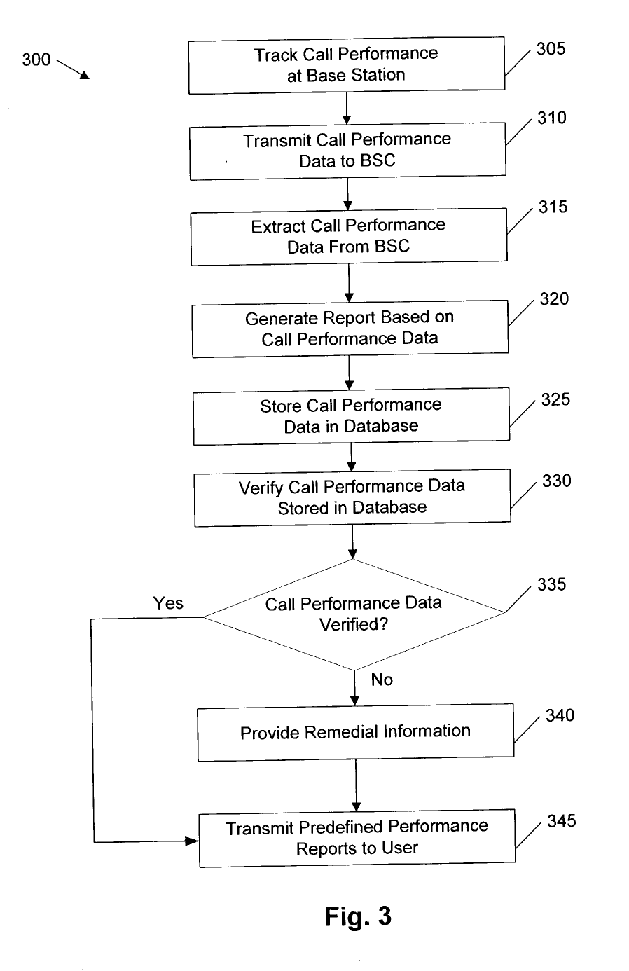

Now referring to FIG. 3, a flow chart of a method 300 for providing verification and remedial reports performed by data integrity checker 390 in accordance with an exemplary embodiment of the present invention is shown. At stage 305, base stations 110 track call performance data within their respective cells and sectors. At stage 310, the call performance data is transmitted to each respective BSC 140. At stage 315, call-report generator 170 receives that information from each BSC 140, including information regarding which BSC, base station, cell, and sector generated the call performance data. It should be appreciated that call report generator 170 may extract information from BSC 140 periodically, as requested, or whenever that information becomes available. At stage 320, call report generator 170 parses the call performance data and generates a report such as a delimited text file. At stage 325, PM tool 190 receives one or more reports from call report generator 170 and loads that information onto query-enabled database 195. Like stage 315, it should be appreciated that PM tool 190 may extract information from call report generator 170 periodically, as requested, or whenever that information becomes available.

At stage 330, data integrity checker 390 executes a report to verify at least part of the information received at stage 325. For example, the report may be limited to specified parameters, such as a specific cell, base station, BSC, or the like. Moreover, the report may be limited to a predefined time duration such as 24 hours. If it is determined at stage 335 that the call performance data has been verified, method 300 proceeds to stage 345, where the report is transmitted to the requesting user. If on the other hand, it is determined one or more items comprising the call performance data could not be verified at stage 335, then method 300 branches to stage 340, where corrective information-is-provided in the status report. At stage 335, the report is then transmitted to the requesting user.

Referring now to FIGS. 4A-4D, an exemplary method, system, and graphical user interface for transmitting a report to mobile computing device 410, such as a PDA, will be further described. As described above, in accordance with one embodiment of the present invention, status reports—such as performance or data integrity reports—are generally text files that are transmitted to a user, e.g., through electronic mail service 405.

For the purposes of illustration, the invention will be described in connection with mobile computing device 410; however, the present invention is equally applicable to other computer systems. For example, in one embodiment of the present invention, the invention may be implemented using a Palm Pilot™ PDA marketed by Palm Corporation of Santa Clara, Calif. The design, manufacture, and use of PDAs is well known to those skilled in the art and typically comprise, among others, a central processing unit (“CPU”), a memory system, an input/output (I/O) dual function display system, and a serial I/O system.

FIGS. 4A-4D illustrate a simplified PDA having a CPU for executing report viewer 455 and an I/O display screen 420 for displaying a graphical user interface (“GUI”) in accordance with aspects of the present invention. Report viewer 455 is operative to receive one or more status reports, such as a performance report discussed with reference to FIG. 2 or a data integrity report discussed with reference to FIG. 3. Transmitting to and from PDAs is well known in the art. Thus, it should be appreciated that status reports may be transmitted to a user's personal computer system prior to download to the user's PDA. It should likewise be appreciated that an intermediate computer, such as a well known SQL or OLAP server, may be used between a user's computer and computer 135 to receive and transmit status reports and to request and define parameters for desired status reports. Those skilled in the art should also appreciate that a complementary program accompanying the report viewer 455 may be stored on the user's computer, thereby allowing a user to manage report viewer 455 and PDA 410 through the user's computer I/O devices.

In accordance with an exemplary embodiment of the present invention, upon receiving one or more status reports, report viewer 455 generates a GUI for displaying the reports. As shown in FIGS. 4A-4D, I/O screen 420 displays a GUI having three selectable tabs: a Settings tab 460, a Connection tab 480, and a Report tab 490. It should be appreciated that the selection of each tab results in the display of different content. For example, referring to FIG. 4A, the selection of Settings tab 460 may display four drop down menus: Report Selection menu 462, Sort Settings menu 464, Select By menu 466, and Display menu 468. Drop down menus provide a list of options when selected and are well known to those skilled in the art.

Report Selection menu 462 permits the user to select and view one of the requested status reports requested and downloaded from computer 135. For example, a user may have previously submitted a set of specified performance parameters to schedule a performance report which was generated by PM tool 190 and transmitted to the user. Sort Settings menu 464 permits the user to sort the selected report by one or more of the fields included in the selected report, e.g., cell, BSC, MSC, geographical area and the like. The selectable fields may be based on the parameters used to generate the report and thus the options marketed by Sort Settings menu 464 depends on the report selected in Report Selection menu 462. It should be appreciated, however, that the selectable fields may be predefined to be independent of the selected report.

Select By menu 466 allows the user to choose a particular element within a provided field. For example, a user may select “BSC” in Select By menu 466. Upon such a selection, a new window may be displayed such as the window shown in FIG. 4D. The window may include a text field box that allows the user to further select a particular BSC for a particular time period. In addition, the window may also include a second text field box that allows the user to select a particular time period. In one embodiment, Settings tab 460 may include a Select button 467, which the user selects before PDA 410 displays the Select window shown in FIG. 4D.

Referring back to FIG. 4A, Settings tab 460 may also include Display menu 468, which allows a user to select the number of items to display in the selected report, e.g., 25, 50, or all. Finally, Settings tab 460 may include buttons 430, 432, and 434 for entering, canceling, and immediately executing the user's selections, respectively.

Referring now to FIG. 4B, Connection tab 480 provides three data entry boxes for entering the computer address, user name, and user password required to access computer 135. It should be appreciated that Connection tab 480 requires connectivity functionality of PDA 410. For example, in one embodiment of the present invention, PDA 410 may comprise a Palm Pilot i705™, which has wireless connectivity and is marketed by Palm Corporation of Santa Clara, Calif. Using such connectivity, a user may directly request and access one or more reports from computer 135.

Referring now to FIG. 4C, Reports tab 490 allows the user to display the report selected from Settings tab 460. It should be appreciated that the user may be able to further select how the report is displayed. For example, the user may select to view the report in table or chart format, text format, or the like.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

Moreover, although the present invention has been described above as implemented in exemplary application program modules, it will be understood that alternative embodiments will become apparent to those skilled in the art to which the present invention pertains without departing from its spirit and scope. Accordingly, the scope of the present invention is defined by the appended claims rather than the foregoing description.

What is claimed is:

1. A method for reporting status data in a telecommunications system comprising the steps of:
receiving call performance data;
storing the call performance data;
receiving call performance parameters from a user;
automatically generating a status report based on the call performance parameters; and
transmitting the status report to the user.

2. The method of claim 1, wherein the call performance parameters include a time for performing the generating step.

3. The method of claim 1, wherein the generating step is performed during a period of low processor use.

4. The method of claim 1, wherein the step of receiving call performance data is performed by an extraction script.

5. The method of claim 1, wherein the status report is transmitted via electronic mail.

6. The method of claim 1, wherein the status report is transmitted via a website.

7. The method of claim 1, wherein the status report is transmitted to a mobile computing device.

8. The method of claim 7, wherein the mobile computing device is a personal digital assistant.

9. The method of claim 1, further comprising the step of parsing the call performance data based on the origin of the data.

10. The method of claim 1, further comprising the step of verifying the call performance data.

11. The method of claim 10, wherein the verifying step is performed by comparing the call performance data with previously stored data.

12. The method of claim 10, further comprising the step of providing remedial information in the status report when the call performance data is incorrect.

13. The method of claim 10, wherein the status report is transmitted to a mobile computing device.

14. The method of claim 13, wherein the mobile computing device is a personal digital assistant.

15. A method for managing quality and service in a telecommunications system comprising the steps of:
transmitting call performance parameters;
generating a status report based on the call performance parameters, wherein the status report is generated at a scheduled time; and
receiving the status report.

16. The method of claim 15, wherein the call performance parameters includes a time for generating the status report.

17. The method of claim 16, wherein the scheduled time is during a period of low processor use.

18. The method of claim 15, wherein the status report is transmitted via electronic mail.

19. The method of claim 15, wherein the status report is transmitted via a website.

20. The method of claim 15, wherein the receiving step is performed at a mobile computing device.

21. The method of claim 20, wherein the mobile computing device is a personal digital assistant.

22. The method of claim 15, wherein the generated status report includes verification of the call performance data.

23. The method of claim 20, wherein the verification is performed by comparing the call performance data with previously stored data.

24. The method of claim 22, wherein the generated status report includes remedial information when the call performance data is incorrect.

25. The method of claim 22, wherein the status report is received at a mobile computing device.

26. The method of claim 25, wherein the mobile computing device is a personal digital assistant.

27. A computer-readable medium having computer executable instruction for:
receiving call performance data;
storing the call performance data;
receiving call performance parameters from a user;
automatically generating a status report based on the call performance parameters; and
transmitting the status report to the user.

28. A computer-readable medium having computer executable instruction for:
receiving call performance data;
storing the call performance data;
verifying the call performance data;
receiving call performance parameters from a user;
automatically generating a status report based on the call performance parameters; and
transmitting the status report to a mobile computing device.
